(19) United States
(12) Patent Application Publication
(10) Pub. No.: US 2026/0159655 A1
(43) Pub. Date: Jun. 11, 2026

(54) Bimodal or multimodal cellulose materials and methods for producing such

(71) Applicant: Teknologian tutkimuskeskus VTT Oy, Espoo (FI)

(72) Inventors: Pia Willberg-Keyriläinen, Espoo (FI); Jarmo Ropponen, Espoo (FI); Ali Harlin, Espoo (FI)

(21) Appl. No.: 18/707,601

(22) PCT Filed: Nov. 4, 2022
(86) PCT No.: PCT/FI2022/050725

§ 371 Date: May 6, 2024

(30) Foreign Application Priority Data
Nov. 5, 2021 (FI) 20216144

(51) Int. Cl. C08J 5/18; C08L 1/02; C08L 1/08; D01F 8/02

(52) U.S. Cl. CPC C08J 5/18; C08L 1/02; C08L 1/08; D01F 8/02; C08J 2301/02; C08J 2301/08

(57) ABSTRACT

According to an example aspect of the present invention, there is provided a method for producing bimodal and/or multimodal cellulose materials, such as films and filaments, which combine the benefits of cellulosic raw materials having different average molecular weight distribution and/or side chain length.

### FIELD

The present invention relates to improved processability and mechanical performance of thermoplastic cellulose materials, and to methods for producing bimodal or multimodal thermoplastic cellulose films having such properties. Bimodality or multimodality in this case relates to combining cellulosic pulps with differing average molecular weights (or molar masses) via cellulose dissolution.

### BACKGROUND

Some recent and partly relevant publications relating to cellulose films aiming for replacing synthetic raw materials exist. For example, WO 2018/228744 A1 discloses a composition comprising a combination of cellulosic polymers, which can be used for manufacturing films or foils. The disclosed cellulose based composition could replace films or foils based on fossil raw materials, and which are used as packing or wrapping materials. However, the cellulosic polymers mentioned in the patent application are selected from the group consisting of cellulose acetate butyrate, cellulose acetate propionate and ethyl cellulose, not for example molecular mass controlled cellulose or any cellulosic material naturally occurring regardless if containing minor components like hemicellulose or lignin for regenerated process.

WO 2019/073370 A1 relates to a process for improving the stretchability of films comprising high amounts of microfibrillated cellulose (MFC) without negatively impacting the oxygen barrier properties. According to the disclosure, a film is formed from a suspension comprising microfibrillated cellulose having a broad size distribution. However, the described method does not apply dissolution of celluloses nor the use of thermoplastic cellulose.

US 2018/0371211 A1 on the other hand discloses a method for producing cellulosic material that has bimodal fibril distribution. The composition can be used to modify rheological properties of components. This US-publication does not, however, relate to methods of preparing cellulose films via for example dissolution nor preparation of thermoplastic cellulose products. Further fibril distribution reflects to particle size and form while here intended molecular weight distribution stands for molecule sizes and optionally type only.

It is known in the art that processability of high molecular weight cellulose solutions is poor, but they usually provide good mechanical properties for cellulose films. Solutions with low molecular weight cellulose are easy to operate due to low solution viscosity, but in turn the prepared cellulose films have poor mechanical properties. Likewise, high molar mass molecules are processable to certain limit in dilute solution, but this procedure is limited and leads to handling high volumes of solvents and thereafter challenges in process and its economy. There is thus a need for a novel technology for achieving thermoplastic cellulose films, fibers and such, which combine both good processability of dissolved cellulose solutions and good mechanical performance of thermoplastic cellulose products.

### SUMMARY OF THE INVENTION

The invention is defined by the features of the independent claims. Some specific embodiments are defined in the dependent claims.

According to an aspect of the present invention, there is provided a method for producing bimodal or multimodal thermoplastic cellulose films and/or filaments and thereby combining the benefits of different thermoplastic cellulose derivatives and/or side chain lengths at least in terms of processability and mechanical performance.

This and other aspects, together with the advantages thereof over known solutions are achieved by the present invention, as hereinafter described and claimed.

The method of the present invention is mainly characterized by what is stated in the characterizing part of claim 1.

The bimodal or multimodal film thereof is mainly characterized by what is stated in the characterizing part of claim 5.

Considerable advantages are obtained by means of the present invention. For example, the processability and mechanical properties of thermoplastic cellulose materials can be improved and genuinely controlled in a desired manner depending on the requirements of the end-products. Better mechanical properties are beneficial for processing and end-use application point of view. The concept enables reaching attractive rheological properties for processing by adding low molecular weight cellulose, maintaining high tensile modulus by adding high molecular weight cellulose and reaching such properties even with high elongations and shorter side chain materials. Furthermore, improved mechanical properties increase the usability of cellulose derivatives (modified long chain fatty acid) and enable the commercialization of the present concept.

Next, the present technology will be described more closely with reference to certain embodiments.

### EMBODIMENTS

The present technology provides improved and controlled processability and mechanical properties of bimodal or multimodal thermoplastic cellulose derivatives by combining low and high molecular weight cellulose derivatives and/or different side chain lengths.

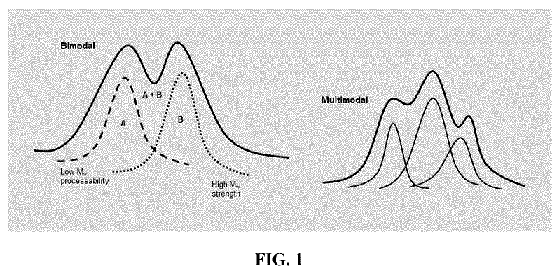

FIG. 1 is a schematic drawing describing the basic idea of bimodal and multimodal molecular weight distribution cellulose materials.

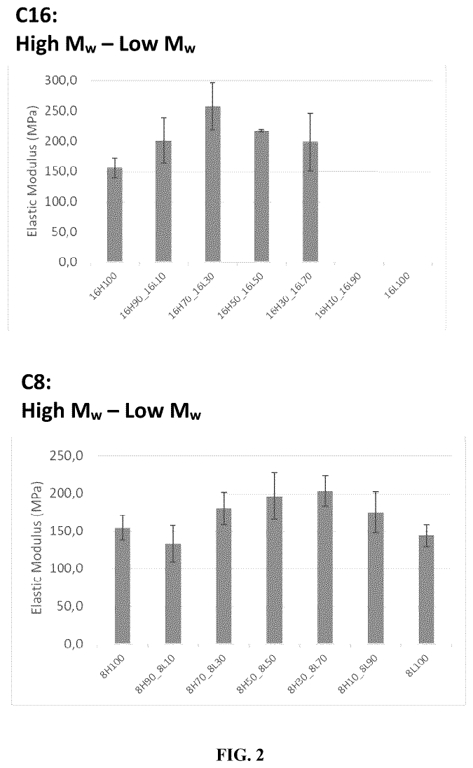

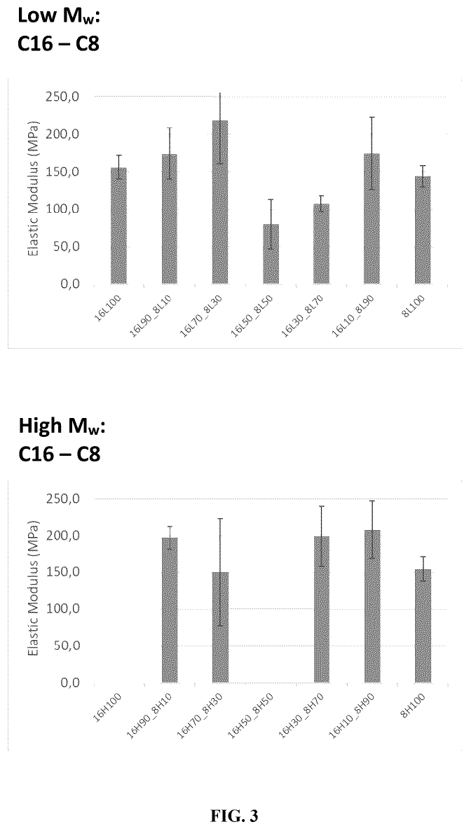

FIG. 2 is a chart describing the effect of molar mass to elastic modulus and FIG. 3 is a chart describing the effect of side chain length to elastic modulus with regard to thermoplastic cellulose films. The marking 16H90_16L10, for example, means that the thermoplastic cellulose derivative mixture consists of 90% high molecular weight thermoplastic cellulose derivative having side chain length of C16 and 10% of low molecular weight thermoplastic cellulose derivative having side chain length of C16. Same type of marking is used in FIGS. 2-7.

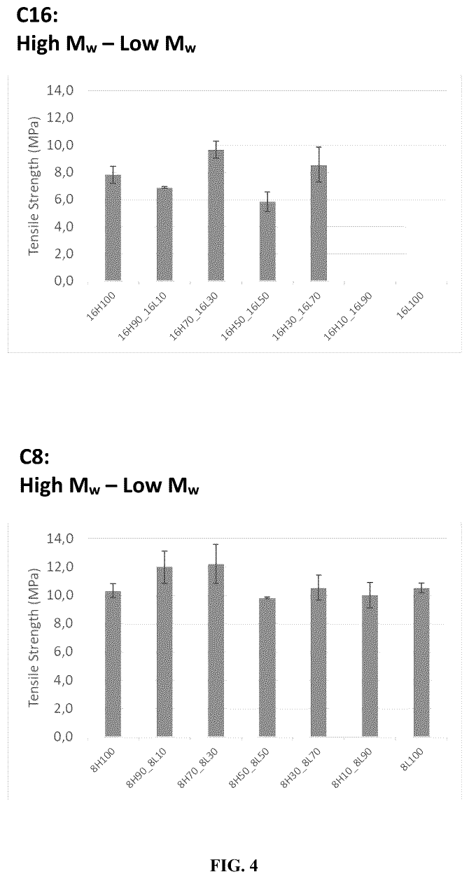

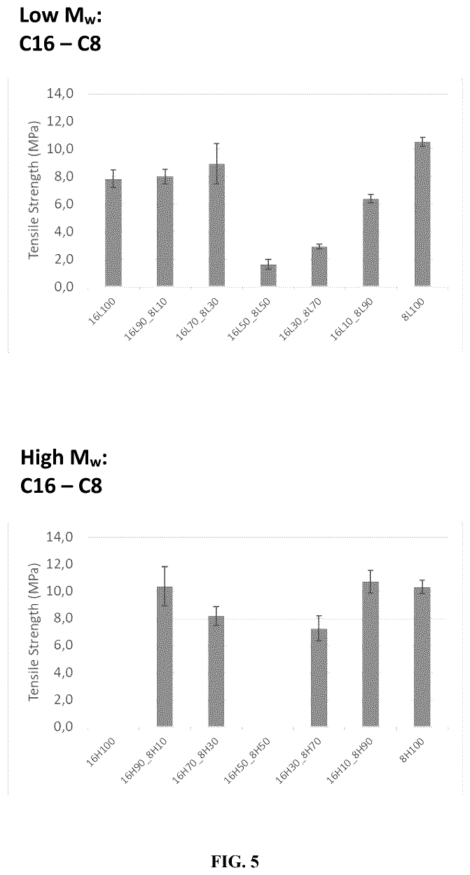

FIG. 4 is a chart describing the effect of molar mass to tensile strength and FIG. 5 is a chart describing the effect of side chain length to tensile strength with regard to thermoplastic cellulose films.

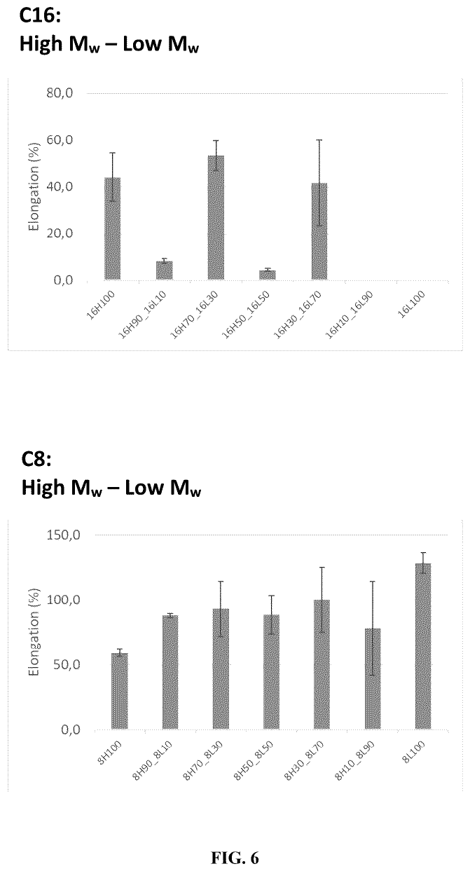

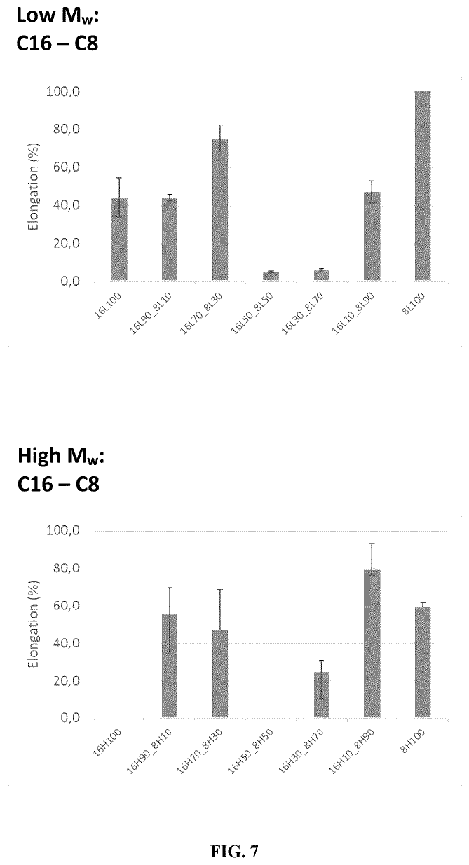

FIG. 6 is a chart describing the effect of molar mass to elongation and FIG. 7 is a chart describing the effect of side chain length to elongation with regard to thermoplastic cellulose films.

In the present context of thermoplastic cellulose derivatives, low molecular weight (M_{w}) cellulose can be anything essentially lower than high M_{w} cellulose, such as for example ⅓ (low/high).

In the present context of thermoplastic cellulose derivatives, high molecular weight (M_{w}) cellulose can be anything essentially higher than low M_{w} cellulose, such as for example 1.5 to 2 times higher (high/low).

Degree of substitution (DS) is the average number of substituent groups attached per base or monomeric unit.

According to an embodiment of the present invention, the method for producing bimodal or multimodal cellulose films and/or filaments comprises at least the steps of:
mixing together thermoplastic cellulose derivatives having at least two different average molecular weights or molecular weight distributions and/or side chain lengths,
dissolving the mixed thermoplastic cellulose derivatives in a solvent and thereby forming a solution, and
solvent-casting the solution into a film or optionally filaments.

According to one embodiment of the present invention, it is preferred to mix together thermoplastic cellulose derivatives having at least two different average molecular weights between 50 and 200 kDa.

According to one embodiment of the present invention, it is preferred to mix together thermoplastic cellulose derivatives having at least two different side chain lengths between C8 and C16.

According to one possible embodiment of the present invention, the at least two thermoplastic cellulose derivatives are dissolved in chloroform.

A bimodal or multimodal cellulose film having elastic modulus at least 100 MPa, tensile strength at least 6 MPa and elongation at least 40% belongs also to the scope of the present invention.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated.

### INDUSTRIAL APPLICABILITY

It is advantageous and industrially attractive to apply bimodal and multimodal systems into cellulosic materials, for combining good properties of different cellulosic raw materials and providing novel and competitive solutions, which can eventually compete with and replace existing synthetic materials.

### EXAMPLES

### Proof-of-Concept-Thermoplastic Cellulose Samples:

TABLE 1
Materials.

| Sample | Sample | M_{w} | DS |
|---|---|---|---|
| C16 low | C16 pilot 4 | 66 | 1 |
| C16 high | C16 A1 | 186 | 1 |
| C8 low | C8 pilot 6 | 68 | 1.4 |
| C8 high | EnzMMCC C8 | 186 | 1.2 |

Thermoplastic cellulose samples were prepared using the homogeneous method presented by Willberg-Keyriläinen et al. (2016 and 2017). The molecular weight of starting pulps and the degree of substitution (DS) of end products were varied.

Films were prepared from the thermoplastic cellulose samples by solvent-casting. Two different grades of thermoplastic cellulose were dissolved in chloroform and poured into a petri dish (diameter 50-100 mm). The solvent was evaporated in air, at room temperature, prior to film formation.

Tensile properties of the thermoplastic cellulose films were measured similarly as presented above with regard to regenerated cellulose films. Results are presented in FIGS. 2-7.

### CITATION LIST

### Patent Literature

1. WO 2018/228744 A1
2. WO 2019/073370 A1
3. US 2018/0371211 A1

### Non-Patent Literature

1. Willberg-Keyriläinen P., Talja R., Asikainen S., Harlin A, Ropponen J., The effect of cellulose molar mass on the properties of palmitate ester, Carbohydrate Polymers, Vol. 151, pp 988-995, 2016, doi: 10.1016/j.carbpol.2016.06.048.
   2. Willberg-Keyriläinen P., Vartiainen J., Harlin A, Ropponen J., The effect of side-chain length of cellulose fatty acid esters, Cellulose, 24, pp 505-517, 2017, doi: 10.1007/s10570-016-1165-x.

1. A method for producing bimodal or multimodal cellulose films and/or filaments, the method comprising:
mixing together thermoplastic cellulose derivatives having at least two different average molecular weights or molecular weight distributions and/or different side chain lengths,
dissolving the mixed thermoplastic cellulose derivatives in a solvent, thereby forming a solution, and
solvent-casting the solution into a cellulose film and/or filaments.

2. The method according to claim 1, wherein thermoplastic cellulose derivatives having at least two different average molecular weights between 50 and 200 kDa are mixed together.

3. The method according to claim 1, wherein thermoplastic cellulose derivatives having at least two different side chain lengths between C8 and C16 are mixed together.

4. The method according to claim 1, wherein the solvent comprises chloroform.

5. A bimodal or multimodal cellulose film produced by the method according to claim 1, wherein the film has an elastic modulus of at least 100 MPa, a tensile strength of at least 6 MPa, and an elongation of at least 40%.

6. (canceled)

7. The method according to claim 1, wherein the thermoplastic cellulose derivatives comprise a first thermoplastic cellulosic derivative having a first average molecular weight and a second thermoplastic cellulose derivative having a second average molecular weight, and wherein the first average molecular weight is from 1.5 to 2 times greater than the second average molecular weight.

8. The method according to claim 1, wherein the thermoplastic cellulose derivatives comprise a first thermoplastic cellulosic derivative having a side chain length of C8 and a second thermoplastic cellulose derivative having a side chain length of C16.
